(19) United States
(12) Patent Application Publication
(10) Pub. No.: US 2014/0034525 A1
(43) Pub. Date: Feb. 6, 2014

(54) Packaging System for Animal Kennel

(71) Applicant: Radio Systems Corporation, Knoxville, TN (US)

(72) Inventors: Marcus Wolf, Knoxville, TN (US); Kevin M. Sayers, Kodak, TN (US); Liu Feng, Zhong Bei Town (CN)

(21) Appl. No.: 14/019,697

(22) Filed: Sep. 6, 2013

(51) Int. Cl. A01K 1/03

(52) U.S. Cl. CPC A01K 1/03
USPC 206/223; 53/473

(57) ABSTRACT

A package for an animal containment system is provided. The package contains a plurality of horizontal support tubes and a plurality of vertical support tubes. The tubes are dimensioned and configured to be joined together by hardware to form a framing for the animal containment system along with a framing for a gate. The packaging includes a plurality of removable fence tubes and a plurality of gate tubes. The fence tubes and gate tubes are configured to be slidably received within aligned openings along the horizontal support tubes. The packaging also includes a box which contains the components for the system. Within the box substantially all of the fence tubes and substantially all of the gate tubes are nested within selected horizontal support tubes and selected vertical support tubes. A method of packaging an animal containment system is also provided herein.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of animal containment systems. More particularly, the invention relates to a novel packaging system for a portable kennel and a novel method for packaging an animal containment system.

### TECHNOLOGY IN THE FIELD OF THE INVENTION

Many pet owners, particularly owners of dogs and domesticated farm animals, desire to keep their pets outdoors. Still other pet owners may choose to keep their pets indoors for most of the day, but choose to allow their pets to spend time outside when the weather is suitable. However, not all pet owners have access to a yard that has a suitable fence or other containment. In those instances, the pet owner may purchase a portable animal containment system.

Animal containment systems are known. These are typically referred to as kennels, runs or pens. Small kennels may be purchased by pet owners at retail pet shops such as PetSmart® of Phoenix, Arizona or Petco Animal Supplies Stores, Inc. of San Diego, Calif. These kennels are larger than a carrying crate and allow an animal such as a dog to move about without wandering off of the property and without being tethered by a leash.

Kennels are also sometimes used by animal care professionals. Such professionals include groomers, trainers and veterinarians. Animal care professionals may use kennels to safely house and segregate dogs.

Kennels come in different shapes and sizes and are constructed out of various materials. Typically, they include a plurality of walls that enclose an interior space, and include a door or gate to provide access to the interior space. Some containment systems also have a floor and/or a covering.

Most known kennels at the retail level are fabricated in one of two ways. First, the kennels may use welded wire frames that are pre-fabricated in panels. The panels are brought home by the owner who then assembles them by connecting plates and brackets to the panels. Hinges may be used for a panel that serves as a door. A tarp fabricated from a soft plastic or polymeric material or a rugged cotton material may be secured on top of the panels to provide a modicum of protection from sun and rain.

If a more sturdy (and less easily transported) kennel is desired, the pet owner may purchase a second type of kennel that uses chain link panels. These kennels come with cylinders and one or more rolls of chain link. The frame is constructed by connecting the cylinders using brackets. The chain link is then connected to a point along the frame. The chain link is wrapped and secured to the cylinders at connection points using brackets and bolts.

As one might imagine, the process of putting together a kennel, particularly a chain link system, is difficult for the end-consumer. Further, the kennel is not well received in terms of aesthetics. In addition, both the welded wire and the chain link kennel systems are difficult for the consumer to transport from the store. Finally, these kennel systems have bulky packaging that are undesirable for the retailer who provides the shelf space.

Therefore, a need exists for a packaging system for an animal kennel that provides a significantly reduced foot print. Further, a need exists for a method of packaging an animal containment system that provides for a reduced foot print.

### BRIEF SUMMARY OF THE INVENTION

A package for an animal containment system is first provided herein. In one embodiment, the package defines a box fabricated from cardboard or plastic. The box may be four-sided, with the sides secured by one or more plastic or nylon straps. Packing tape may be used alternatively, or in addition.

The box is dimensioned to hold components of the animal containment system. The animal containment system generally comprises a plurality of first horizontal support tubes and a plurality of first vertical support tubes. Each of the first horizontal and vertical support tubes is dimensioned and configured to be joined together by hardware to form a framing for the containment system. The framing reserves an opening for a gate.

The animal containment system also comprises a plurality of second horizontal support tubes and a plurality of second vertical support tubes. The second horizontal and vertical support tubes are dimensioned and configured to be joined together by hardware to form a framing for the gate. Upon assembly, the gate is hingedly connected to the framing for the containment system using hardware.

The animal containment system also includes a plurality of removable fence tubes. The fence tubes are configured to be slidably received within aligned openings along the first horizontal support tubes. Additionally, the animal containment system includes a plurality of removable gate tubes. The gate tubes are configured to be slidably received within aligned openings along the second horizontal support tubes and between the second vertical support tubes.

The plurality of first horizontal support tubes, the plurality of second horizontal support tubes, the plurality of first vertical support tubes, the plurality of second vertical support tubes, and the hardware are packaged within the box. In the present invention, packaging is done through a novel system wherein substantially all (and preferably all) of the fence tubes are nested within selected first horizontal support tubes and selected first vertical support tubes, and substantially all (and preferably all) of the gate tubes are also nested within selected first horizontal support tubes and selected first vertical support tubes within the box.

In one aspect, each support tube is hollow and may nest up to four fence tubes or gate tubes. In one embodiment, at least two of the fence tubes are nested within a selected second vertical support tube. In another embodiment, at least two of the gate tubes are also nested within a selected second vertical support tube.

In one aspect, when assembled, the animal containment system is about five feet in length, five feet in width, and five feet in height. In one aspect, the package includes a tarp that is configured to cover the containment system when it is assembled.

A method of packaging an animal containment system is also provided herein. In one aspect, the method includes providing a box. The box is preferably fabricated from cardboard or plastic. Preferably, the box is an elongated cardboard box having four sides.

The method also includes placing components of the animal containment system into the box. The components generally comprise:
a plurality of first horizontal support tubes and a plurality of first vertical support tubes, wherein the first horizontal and first vertical support tubes are dimensioned and configured to be joined together by hardware to form a framing for the containment system, with the framing reserving an opening for a gate;
a plurality of second horizontal support tubes and a plurality of second vertical support tubes, wherein the second horizontal and second vertical support tubes are dimensioned and configured to be joined together by hardware to form a framing for the gate, with the gate being hingedly connected to the framing for the containment system;
a plurality of removable fence tubes, the fence tubes being configured to be slidably received within aligned openings along the first horizontal support tubes; and
a plurality of removable gate tubes, the gate tubes being configured to be slidably received within aligned openings along the second horizontal support tubes.

The method also includes nesting substantially all of the fence tubes within selected first horizontal support tubes and selected first vertical support tubes within the box. The method further includes nesting substantially all of the gate tubes within selected first horizontal support tubes and selected first vertical support tubes within the box. The method then includes securing the box.

The method may further comprise nesting at least two of the fence tubes within a selected second vertical support tube within the box. Alternatively or in addition, the

method may comprise nesting at least two of the gate tubes within a selected second vertical support tube within the box.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal containment system as may be used in the packaging system of the present invention, in one embodiment. The system includes four side walls and an access gate.

FIG. 2A is an enlarged side view of a horizontal support tube as used in the assembly of the animal containment system of FIG. 1. Receiving holes are seen along the support tube.

FIG. 2B is an enlarged side view of a vertical support tube as used in the assembly of the animal containment system of FIG. 1. Female receptacles are seen along the support tube.

FIG. 2C is an enlarged side view of a horizontal support tube placed adjacent the gate as used in the assembly of the animal containment system of FIG. 1.

FIG. 2D is an enlarged side view of a vertical support tube that runs adjacent the gate as used in the assembly of the animal containment system of FIG. 1. A female receptacle is seen along the support tube.

FIG. 2E is an enlarged side view of an intermediate horizontal support tube as used in the assembly of the animal containment system of FIG. 1. Receiving holes are seen along the support tube.

FIG. 3 is a side view of a fence tube as used in the assembly of the animal containment system of FIG. 1. The fence tubes are installed vertically.

FIG. 4A is a perspective view of a corner clamp as used in the assembly of the animal containment system of FIG. 1.

FIG. 4B is a perspective view of a corner brace as used in the assembly of the animal containment system of FIG. 1.

FIG. 5A is a perspective view of a flat brace as used in the assembly of the animal containment system of FIG. 1.

FIG. 5B is a perspective view of a tube plug as optionally used in the assembly of the animal containment system of FIG. 1.

FIG. 6 is a perspective view of a carriage bolt and a nut as used in the assembly of the animal containment system of FIG. 1. Multiple bolts and nuts are used in the assembly process.

FIG. 7A is a perspective view of a tarp as may be optionally placed over the animal containment system of FIG. 1.

FIG. 7B is a perspective view of a cable tie as may be used to fasten the tarp of FIG. 7A to the animal containment system of FIG. 1.

FIG. 8A is a side view of a horizontal support tube as used in the assembly of the gate of the animal containment system of FIG. 1. Receiving holes are seen along the support tube.

FIG. 8B is an enlarged side view of a vertical support tube as used in the assembly of the gate of the animal containment system of FIG. 1. Female receptacles are seen along the support tube.

FIG. 8C is a side view of a gate tube as used in the assembly of the gate of the animal containment system of FIG. 1. The gate tubes are installed vertically.

FIG. 9A is a perspective view of a gate clamp as used in the assembly of the gate of the animal containment system of FIG. 1.

FIG. 9B is a perspective view of a gate latch as used in the assembly of the gate of the animal containment system of FIG. 1.

FIGS. 10A through 10C demonstrate steps for assembling the gate of the animal containment system of FIG. 1.

FIGS. 11A through 11G demonstrate steps for assembling the framing for the animal containment system of FIG. 1.

FIG. 12 is a perspective view of the animal containment system of FIG. 1 wherein the framing has received fence tubes.

FIGS. 13A through 13D demonstrate steps for installing the gate and completing the assembly of the animal containment system of FIG. 1.

FIG. 14 is another perspective view of the animal containment system of FIG. 1, in a completed state. Here, the optional tarp has been secured over the containment system.

FIG. 15A is a photographic view of an end of a support tube. The support tube has received a fence tube.

FIG. 15B is an exploded perspective view showing a support tube ready to receive four fence tubes.

FIG. 16 is a photographic view of a packaging having received the various components from the animal containment system of FIG. 1.

FIG. 17 is a perspective view of a crate supporting a plurality of packages from FIG. 16, in stacked relation.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

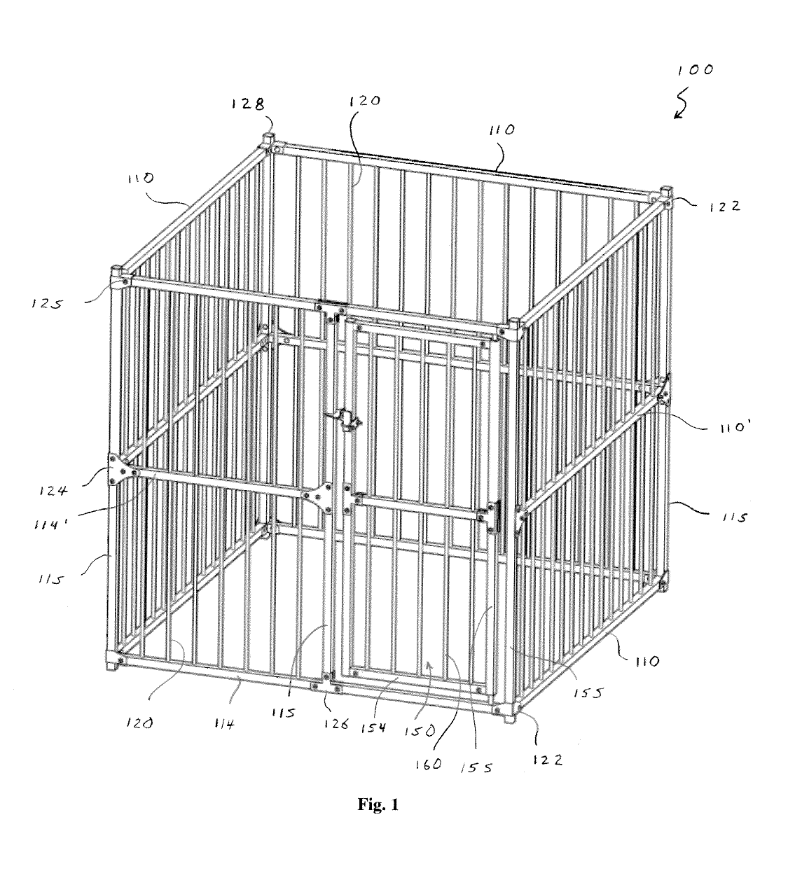

FIG. 1 is a perspective view of an animal containment system 100. The animal containment system 100 is an example of a kennel as may be used in a packaging system of the present invention. The packaging system itself is described in further detail below.

The illustrative animal containment system 100 includes four side walls and an access gate 150. The side walls are generally made up of framing tubes 110, 110′, 114, 115 and fence tubes 120. The gate 150 is likewise generally made up of framing tubes 154, 155 and gate tubes 160. In all cases for the illustrative animal containment system 100 the fence tubes 120 and the gate tubes 160 are vertical.

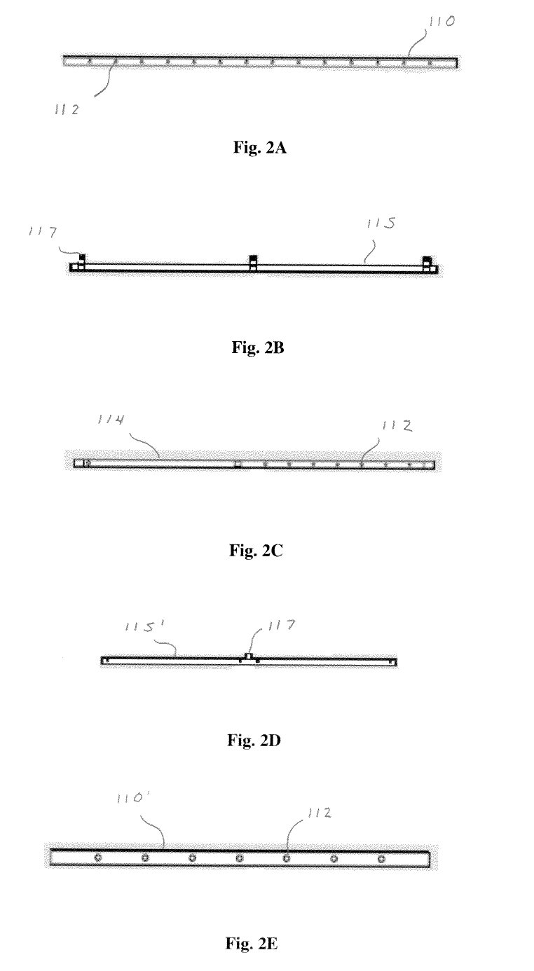

FIG. 2A is an enlarged side view of a horizontal support tube 110 as used in the assembly of the animal containment system 100 of FIG. 1. The horizontal support tube 110 contains a plurality of receiving holes 112 along its length. As seen best in FIG. 12, the receiving holes 112 are dimensioned to receive respective ends of fence tubes 120.

In FIG. 1, horizontal support tubes 110 are shown forming top and bottom frames for the animal containment system 110. However, the animal containment system 100 also utilizes intermediate horizontal support tubes, indicated at 110′. The intermediate horizontal support tube 110′ may be dimensioned like the horizontal support tube 110 of FIG. 2A, except that the horizontal support tubes 110′ will each have receiving holes 112 on both of opposing sides. In this way, the fence tubes 120 actually slide through the horizontal support tubes 110′.

Of interest, the horizontal support tubes 110 (including the intermediate horizontal support tubes 110′) are hollow. An inner diameter is formed within the support tubes 110 to hold a plurality of fence tubes 120 during packaging. In one aspect, as many as four fence tubes 120 are housed. This is demonstrated best in FIG. 15B, discussed below.

FIG. 2B is a side view of a vertical support tube 115 as used in the assembly of the animal containment system 100 of FIG. 1. The vertical support tube 115 contains a plurality of female receptacles 117. The female receptacles 117 are sized to receive ends of the horizontal support tubes 110, 110′.

FIG. 2C is an enlarged side view of a horizontal support tube 114 used to support the gate 150. The horizontal support tube 114 may be dimensioned like the horizontal support tube 110 of FIG. 2A, except that its receiving holes 112 preferably do not extend along the entire length of the tube 114.

FIG. 2D is an enlarged side view of a vertical support tube 115′ that runs adjacent the gate 150. The vertical support tube 115 includes a female receptacle 117 that is sized to receive the end of a horizontal support tube 114′.

FIG. 2E is an enlarged side view of an intermediate support tube 110′ as used in the assembly of the animal containment system 100 of FIG. 1. Receiving holes 112 are seen along the length of the tube 110′.

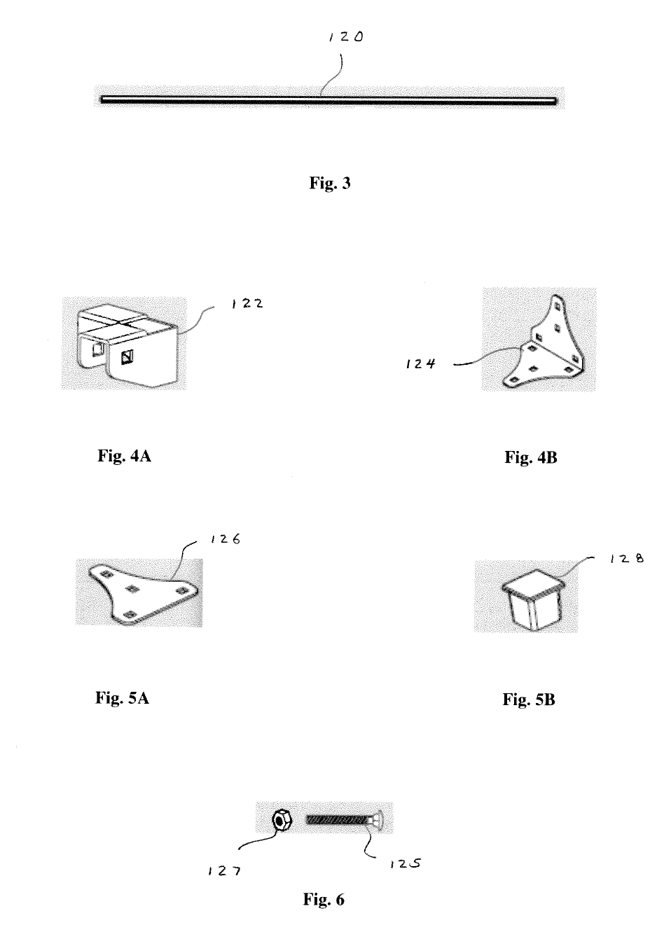

FIG. 3 is a side view of a fence tube 120 as used in the assembly of the animal containment system of FIG. 1. In the illustrative arrangement of FIG. 1, 49 fence tubes 120 are used. Additionally, five gate tubes 160, which are slightly shorter than the fence tubes 120, are used.

In assembling the tube-based containment system 100, various clamps and brackets are used. FIG. 4A is an enlarged perspective view of a corner clamp 122 as used in the assembly of the animal containment system 100 of FIG. 1. FIG. 4B is a perspective view of a corner brace 122. In the illustrative arrangement of FIG. 1, eight corner clamps 122 and three corner braces 124 are used in the framing.

FIG. 5A is a perspective view of a flat brace 126 as used in the assembly of the animal containment system 100 of FIG. 1. FIG. 5B is a perspective view of a tube plug 128 as optionally used. In the illustrative arrangement of FIG. 1, two flat braces 126 and five tube plugs 128 are used in the framing.

The hardware is secured to the framing by bolts. FIG. 6 is a perspective view of a carriage bolt 125 and a nut 127 as used in the assembly of the animal containment system 100 of FIG. 1. In the illustrative arrangement of FIG. 1, 58 carriage bolts 125 are used.

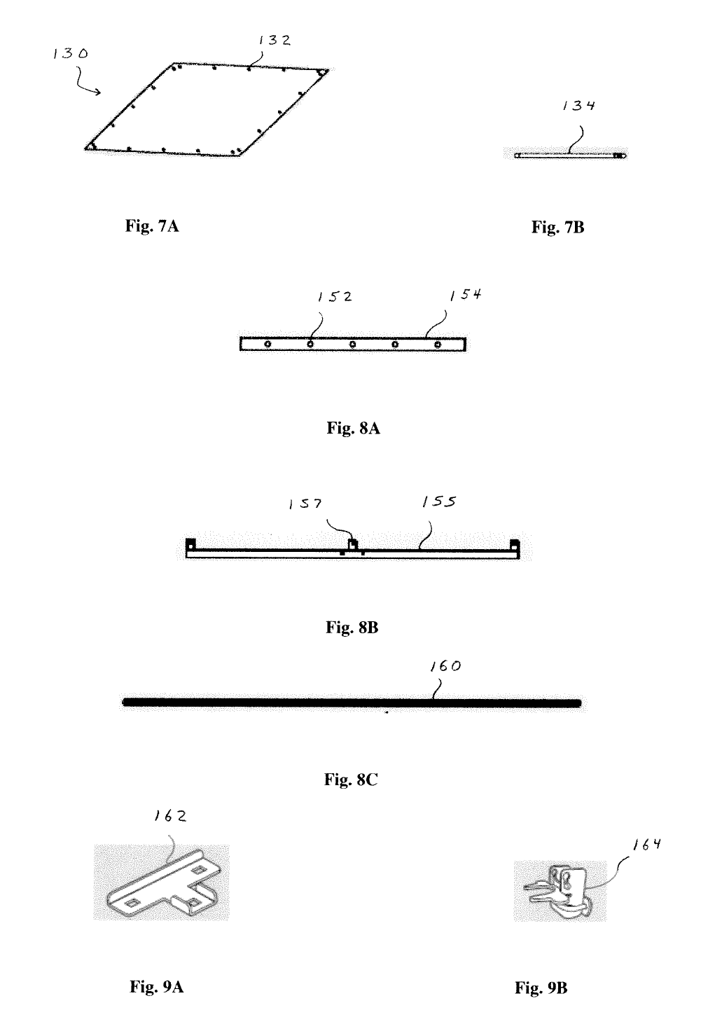

The animal containment system 100 may optionally utilize a tarp. FIG. 7A is a perspective view of a tarp 130 as may be optionally placed over the animal containment system 100. The tarp 130 is secured to the framing using cable ties. FIG. 7B is an enlarged perspective view of a cable tie 134 as may be used to fasten the tarp 130 of FIG. 7A to the animal containment system 100 of FIG. 1. The cable ties 134 are run through openings 132 provided around a perimeter of the tarp 130.

As noted above, the animal containment system 100 also includes a gate 150. The gate 150 includes components that are analogous to some components of the framing. FIG. 8A is an enlarged side view of a horizontal support tube 154. The horizontal support tube 154 includes holes 152 along its length for receiving the gate tubes 160.

FIG. 8B is an enlarged side view of a vertical support tube 155 as used in the assembly of the gate 150. The vertical support tube 155 includes female receptacles 157 dimensioned to receive horizontal support tubes 154. An intermediate horizontal support tube 154′ is also shown.

FIG. 8C is an enlarged side view of an illustrative gate tube 160.

The gate 150 includes hardware components. FIG. 9A is a perspective view of a gate clamp 162 as used in the assembly of the gate 150 of the animal containment system 100 of FIG. 1. In the illustrative arrangement of FIG. 1, eight gate clamps 162 are used.

FIG. 9B is a perspective view of a gate latch 164 as used to secure the gate 150.

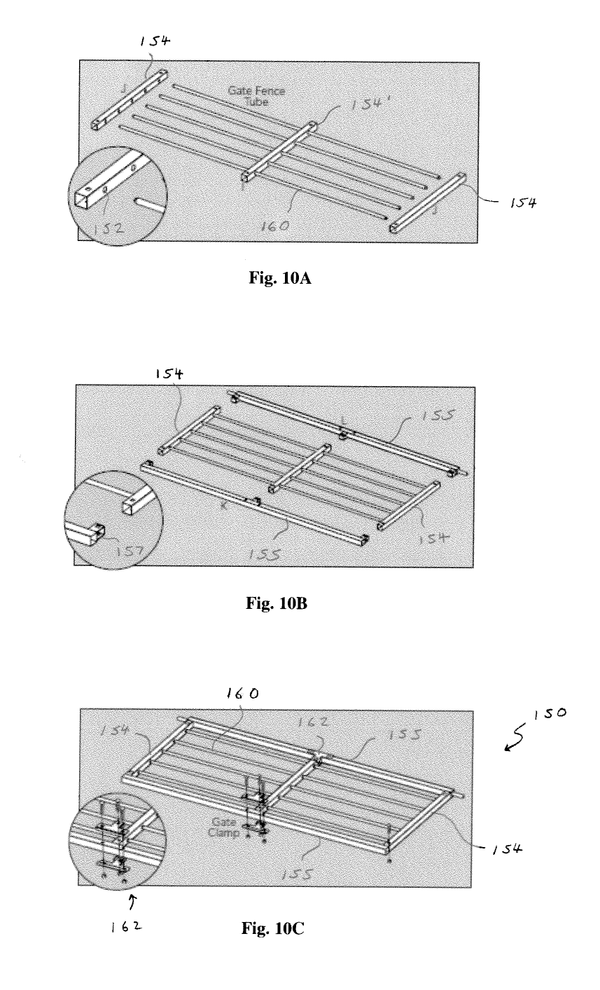

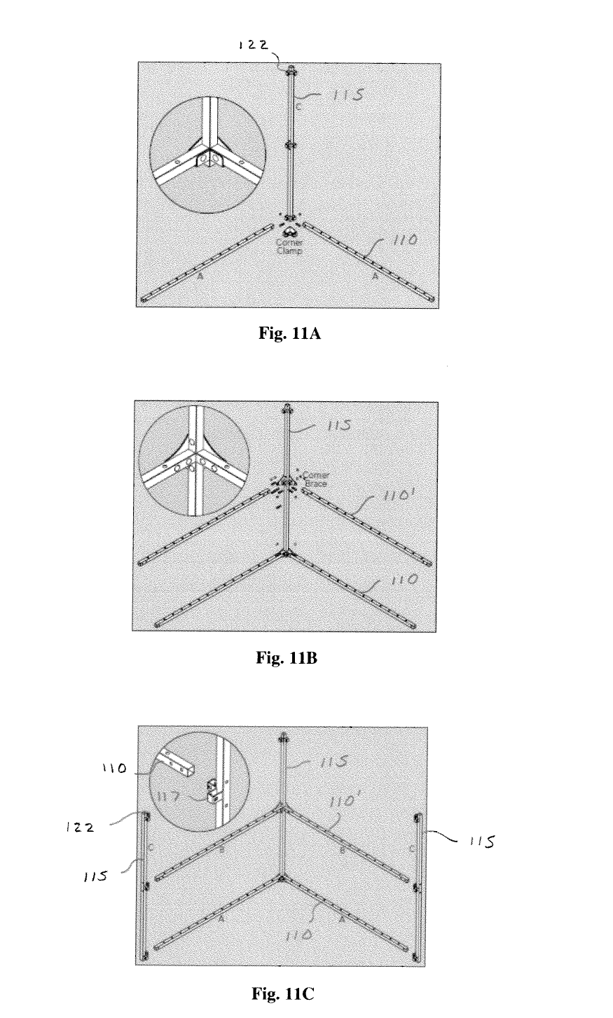

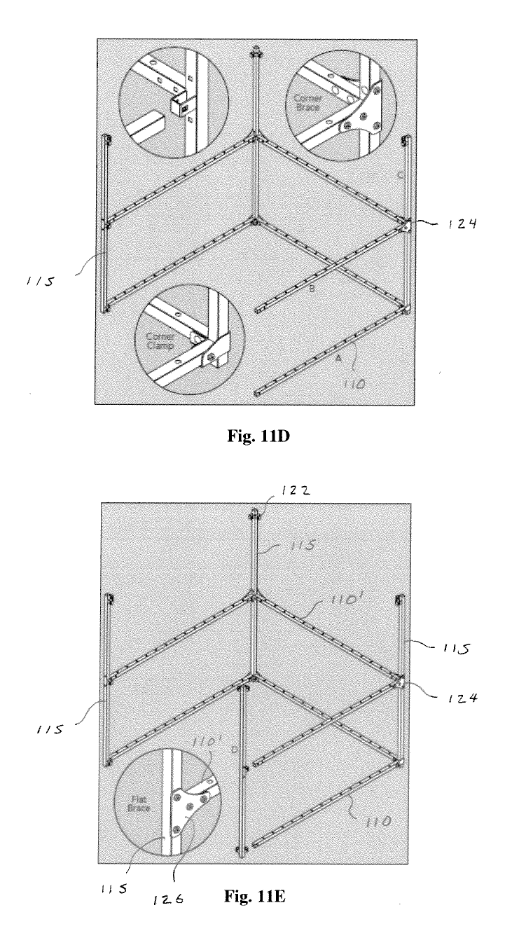

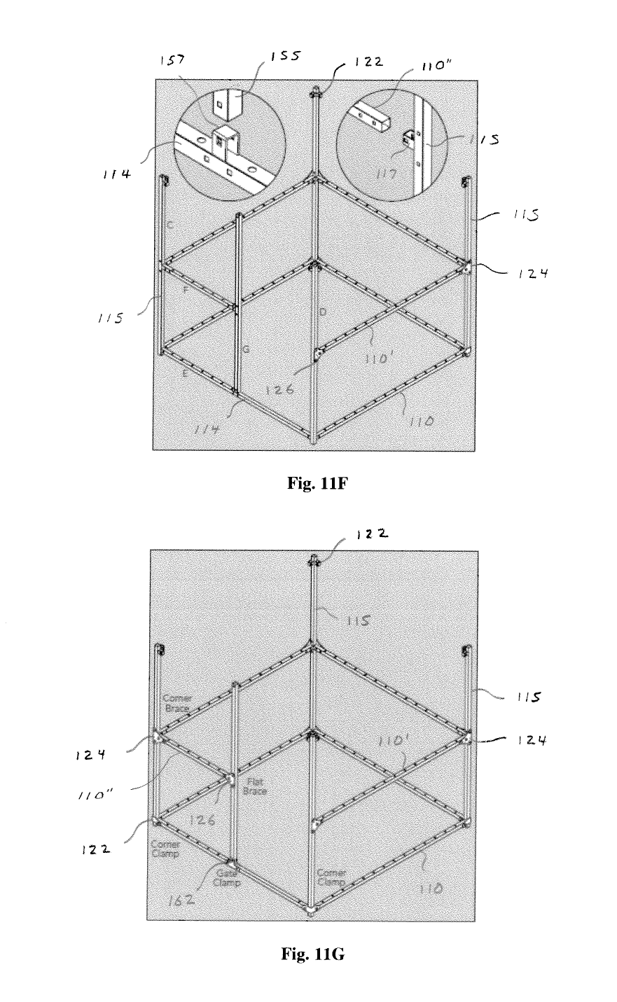

FIGS. 10A through 10C demonstrate steps for assembling the gate 150 of the animal containment system of FIG. 1. In FIG. 10A, an enlarged portion shows a gate tube 160 being placed into a receiving hole 152. In FIG. 10B, an enlarged portion shows a horizontal support tube 154 being placed into a female receptacle 157. In FIG. 10C, an enlarged portion shows gate clamps 162 being fastened onto framing of the gate 150.

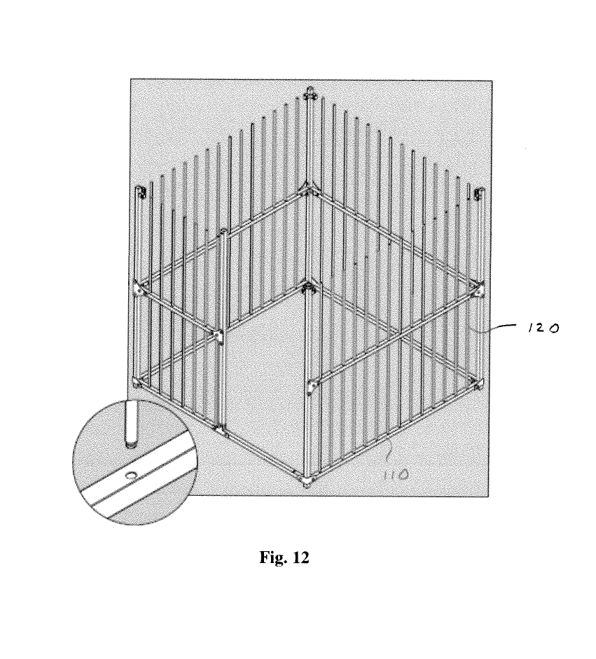

FIGS. 11A through 11G demonstrate steps for assembling the framing for the animal containment system 100 of FIG. 1.

In FIG. 11A, an enlarged portion shows a corner bracket 122 securing two horizontal support tubes 110 and a vertical support tube 115 together for framing.

In FIG. 11B, an enlarged portion shows a corner brace 124 securing two intermediate horizontal support tubes 110′ and the vertical support tube 115 together.

In FIG. 11C, an enlarged portion shows a horizontal support bar 110 being placed into a female receptacle 117.

In FIG. 11D, enlarged portions show additional framing steps using corner brackets 122, corner braces 124 and female receptacles 117.

In FIG. 11E, an enlarged portion shows a flat brace 126 securing a vertical support tube 115 to an intermediate horizontal support tube 110′.

In FIG. 11F, an enlarged portion shows steps for framing the gate 150. A female receptacle 157 of tube 114 is receiving a vertical support tube 155. Also, a female receptacle 117 of a vertical support tube 115 is receiving an intermediate horizontal support tube 110′.

In FIG. 11G, a gate clamp 162, corner clamps 122, and flat braces 126 are added to the framing.

FIG. 12 is a perspective view of the animal containment system 100 of FIG. 1 wherein the framing has received fence tubes 120. 49 fence tubes 120 are provided within the framing.

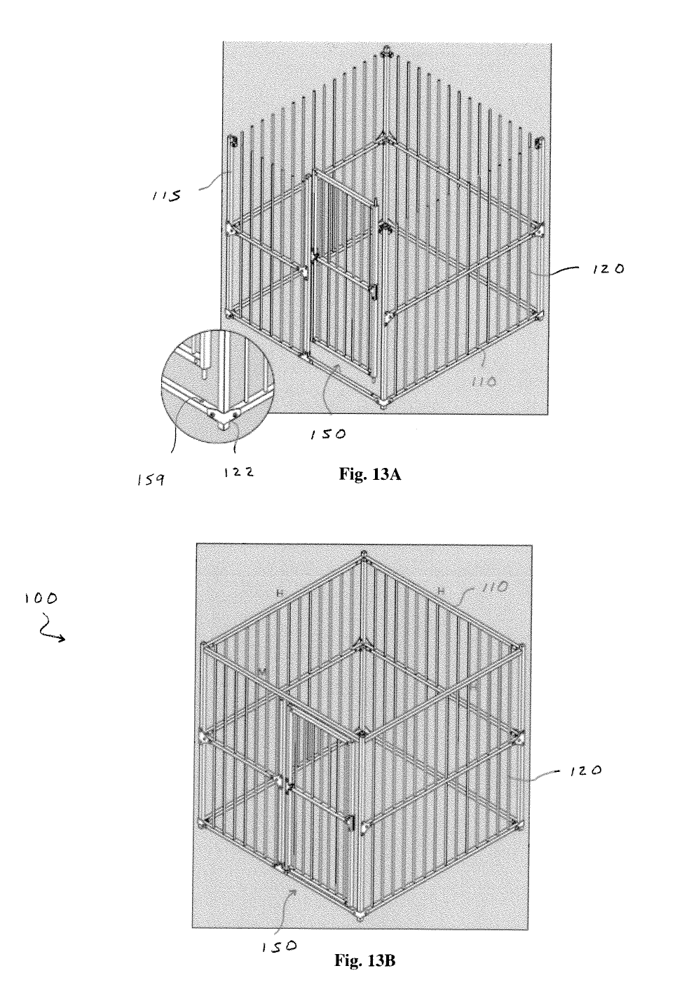

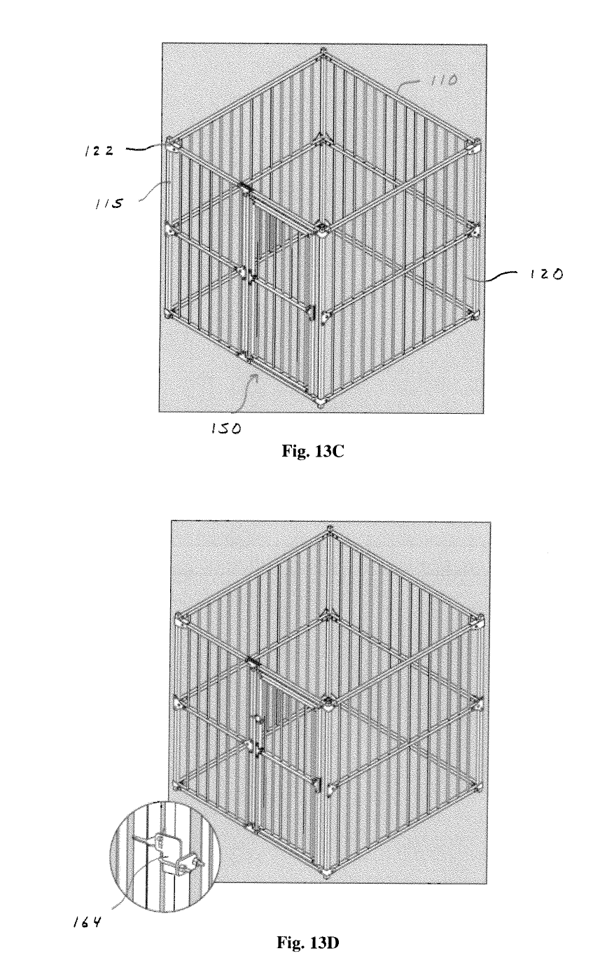

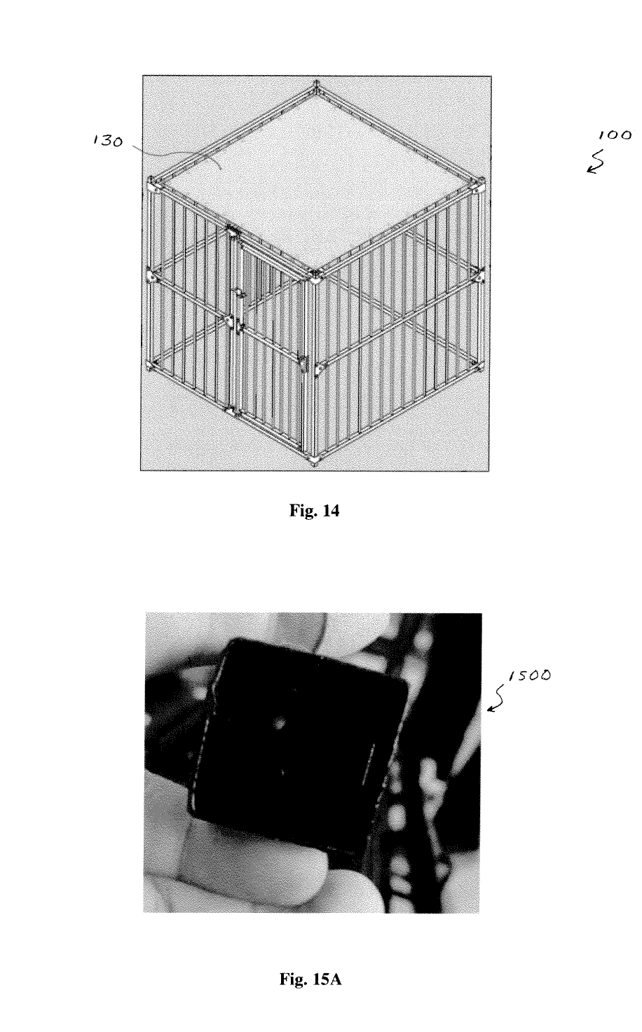

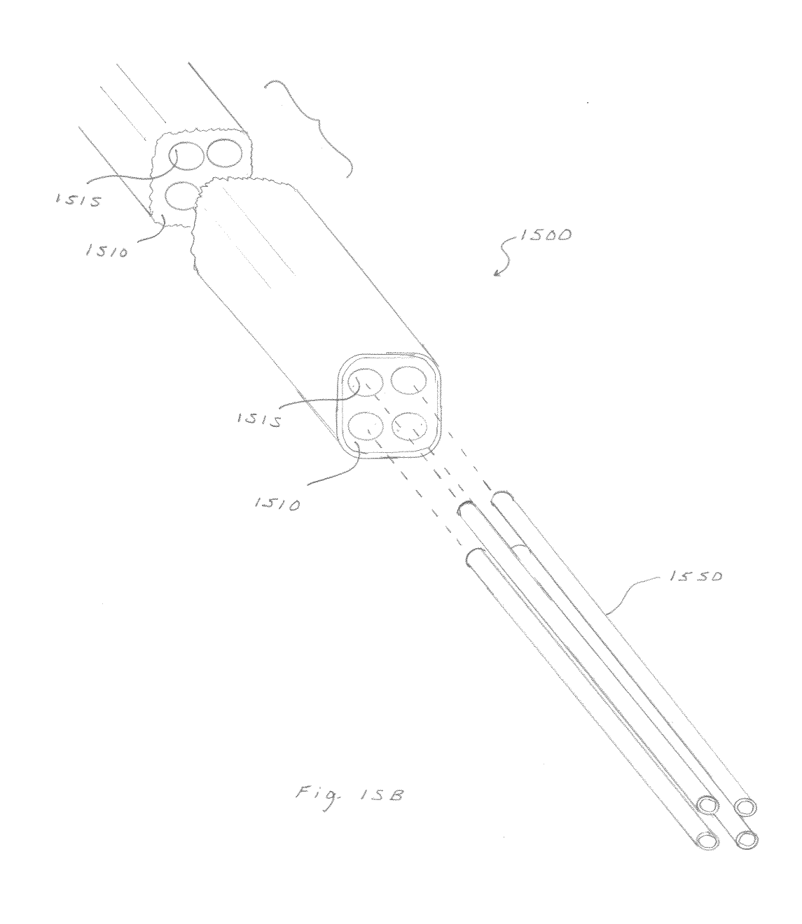

FIGS. 13A through 13D demonstrate steps for installing the gate 150 and completing the assembly of the animal containment system of FIG. 1.

In FIG. 13A, an enlarged portion shows the framing of the gate 150 being dropped into a swivel opening 159.

In FIG. 13B, horizontal support tubes 110 have been secured onto the tops of the fence tubes 120 around the perimeter of the system 100.

In FIG. 13C, corner clamps 122 are installed along the top of the system 100.

In FIG. 13D, the gate latch 164 is installed into the gate 150.

FIG. 14 is another perspective view of the animal containment system 100 of FIG. 1, in a completed state. Here, the optional tarp 130 has been secured over the containment system 100.

FIG. 15A is a photographic view of an end of a horizontal support tube 1500. The support tube 1500 may be any of horizontal support tubes 110, 110′, 114, 154, 154′. Alternatively, the support tube 1500 may be any of vertical support tubes 115, 155. What is of note is that the support tube 1500 is hollow and has an inner diameter that is dimensioned to receive a plurality of either fence tubes 120 or gate tubes 160.

The horizontal support tube 1500 shows a base. The base includes four circular slots, with one of the slots having been filled by one of the fence tubes 120. The photograph shows that four fence tubes may be inserted into the slots. Alternatively, gate tubes may be inserted into the slots.

FIG. 15B is an exploded perspective view showing a horizontal support tube 1500 ready to receive four fence tubes 1550. The support tube 1500 has a generally square profile, while the fence tubes 1550 have a general circular profile. To support the fence tubes 1550, a manifold 1510 is provided at different points along the length of the support tube 1500. The manifold has four illustrative openings 1515 that receive respective fence tubes 1550.

The concept of nesting multiple fence tubes 1550 into a single support tube 1500 has two advantages. First, it allows the volume of packaging required to hold the fence tubes 1550 to be substantially reduced. In this respect, the volume occupied by the fence tubes 1550 and the volume occupied by the support tube 1500 within a package is shared. Second, using fence tubes 1550 that break down from the support tubes 1500 means that the consumer is not required to haul pre-packaged panels or heavy steel poles from the store to his or her home or place of business. Instead, components of the animal containment system fit densely into a box.

The various tubes are preferably fabricated from plastic, aluminum or other light-weight material.

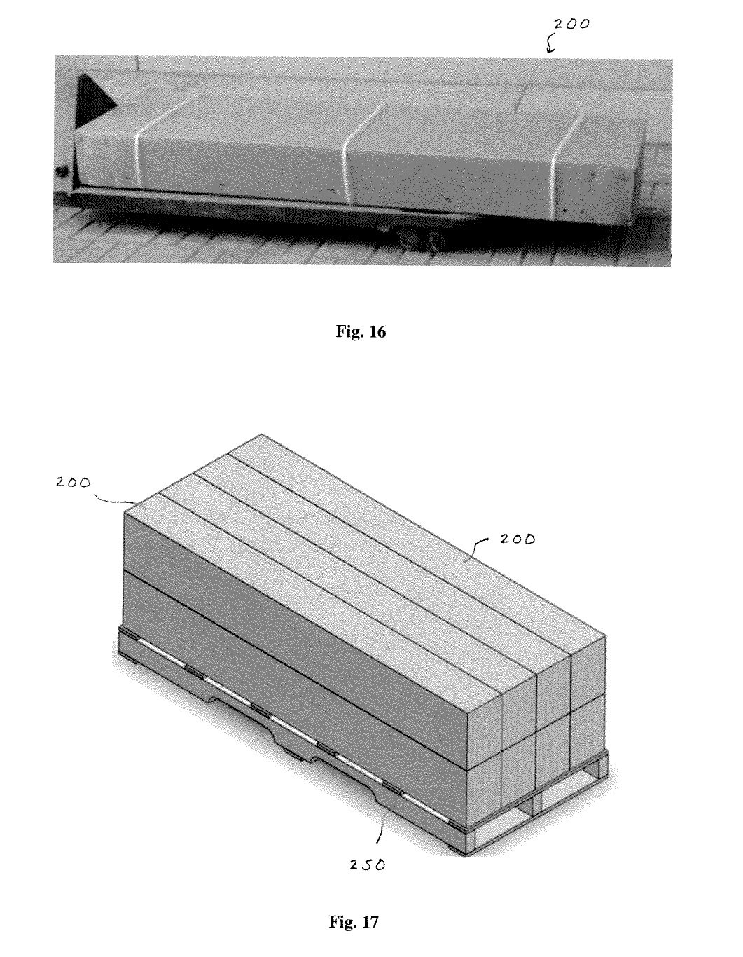

FIG. 16 is a photographic view of a package 200 having received the various components from the animal containment system 100 of FIG. 1. The package 200 comprises a box that contains components of the animal containment system. The box is fabricated from cardboard or plastic. In one aspect, the box is about 6 feet in length, two feet in width, and one foot in thickness. The box is preferably secured by one or more circumferentially-wrapped plastic or nylon straps. Alternatively or in addition, packing tape may be used.

FIG. 17 is a perspective view of a crate 250 having received a plurality of packages 200 from FIG. 16, in stacked relation. The individual packages 200 contain fence tubes and gate tubes nested within horizontal support tubes.

The following tubes make up the framing for the illustrative system 100 of FIG. 1:

| | |
|---|---|
| Upper Horizontal Support Tube 110 (over three panels) | (3 pieces) |
| Lower Horizontal Support Tube 110 (under three panels) | (3 pieces) |
| Intermediate Horizontal Support Tube 110′ | (3 pieces) |
| Upper Horizontal Support Tube 110 (over gate) | (1 piece) |
| Lower Horizontal Support Tube 114 (under gate) | (1 piece) |
| Intermediate Horizontal Support Tube 114′ | (1 piece) |
| Vertical Support Tube 115 | (5 pieces) |
| Vertical Support Tube 155 (along gate) | (2 pieces) |
| Upper Horizontal Support Tube 154 (on top of gate) | (1 piece) |
| Lower Horizontal Support Tube 154 (on bottom of gate) | (1 piece) |
| Intermediate Horizontal Support Tube 154′ | (1 piece) |

This is a total of 22 tubes. Only 18 of these tubes are considered full length. In this case, full length is about five feet.

The following tubes make up the fence and gate tubes of the illustrative system 100:

| | |
|---|---|
| Fence Tubes 120 | (49 pieces) |
| Gate Tubes 160 | (5 pieces) |

If each of the 18 full-length support tubes (or framing tubes) was to hold four of the fence or gate tubes, then 72 fence and gate tubes could be nested. As noted, only 54 of such tubes exist, so there is plenty of space to accommodate the fence tubes 120 and the gate tubes 160 within the various framing tubes.

The multi-tube nesting arrangement means that additional packaging space is not taken up by the 49 vertical fence tubes and the 5 vertical gate tubes. The result is that a much smaller footprint is needed for shelving of the packages in the retail environment.

A method of packaging an animal containment system is also provided herein. In one aspect, the method first includes providing a box. The box is preferably fabricated from cardboard or plastic. Preferably, the box is an elongated cardboard box having four sides.

The method also includes placing components of the animal containment system into the box. The components generally comprise:
a plurality of first horizontal support tubes and a plurality of first vertical support tubes, wherein the first horizontal and first vertical support tubes are dimensioned and configured to be joined together by hardware to form a framing for the containment system, with the framing reserving an opening for a gate;
a plurality of second horizontal support tubes and a plurality of second vertical support tubes, wherein the second horizontal and second vertical support tubes are dimensioned and configured to be joined together by hardware to form a framing for the gate, with the gate being hingedly connected to the framing for the containment system;
a plurality of removable fence tubes, the fence tubes being configured to be slidably received within aligned openings along the first horizontal support tubes; and
a plurality of removable gate tubes, the gate tubes being configured to be slidably received within aligned openings along the second horizontal support tubes.

The method also includes nesting substantially all of the fence tubes within selected first horizontal support tubes and selected first vertical support tubes within the box. The method further includes nesting substantially all of the gate tubes within selected first horizontal support tubes and selected first vertical support tubes within the box. The method then includes securing the box. Securing the box, in one aspect, comprises taping edges of the box, wrapping the box with tape, or wrapping the box with one or more straps.

The method may further comprise nesting at least two of the fence tubes within a selected second vertical support tube within the box. Alternatively or in addition, the method may comprise nesting at least two of the gate tubes within a selected second vertical support tube within the box.

We claim:

1. A package for an animal containment system, comprising:
a plurality of first horizontal support tubes and a plurality of first vertical support tubes, wherein the first horizontal and first vertical support tubes are dimensioned and configured to be joined together by hardware to form a framing for the containment system, with the framing reserving an opening for a gate;
a plurality of second horizontal support tubes and a plurality of second vertical support tubes, wherein the second horizontal and second vertical support tubes are dimensioned and configured to be joined together by hardware to form a framing for the gate, with the gate being hingedly connected to the framing for the containment system;
a plurality of removable fence tubes, the fence tubes being configured to be slidably received within aligned openings along the first horizontal support tubes to form sides;
a plurality of gate tubes, the gate tubes being configured to be slidably received within aligned openings along the second horizontal support tubes;
a box containing the plurality of first horizontal support tubes, the plurality of second horizontal support tubes, the plurality of first vertical support tubes, the plurality of second vertical support tubes, and the hardware; and
wherein:
substantially all of the fence tubes are nested within selected first horizontal support tubes and selected first vertical support tubes; and
substantially all of the gate tubes are nested within selected first horizontal support tubes and selected first vertical support tubes within the box.

2. The package of claim 1, wherein:
at least two of the fence tubes are nested within a selected second vertical support tube.

3. The package of claim 1, wherein:
at least two of the gate tubes are nested within a selected second vertical support tube.

4. The package of claim 1, wherein the box is fabricated from cardboard or plastic.

5. The package of claim 1, wherein the box is about 6 feet in length, two feet in width, and one foot in thickness.

6. The package of claim 1, wherein, when assembled, the animal containment system is about five feet in length, five feet in width, and five feet in height.

7. The package of claim 1, further comprising a tarp configured to provide a cover over the animal containment system when the system is assembled.

8. The package of claim 1, wherein the hardware comprises female receptacles along at least the first vertical support tubes, with the female receptacles being dimensioned to receive ends of the first horizontal support tubes.

9. A method of packaging an animal containment system, comprising:
providing a box;
placing components of the animal containment system into the box, said components comprising:
a plurality of first horizontal support tubes and a plurality of first vertical support tubes, wherein each of the first horizontal and vertical support tubes are dimensioned and configured to be joined together by hardware to form a framing for the containment system, with the framing reserving an opening for a gate;
a plurality of second horizontal support tubes and a plurality of second vertical support tubes, wherein each of the second horizontal and vertical support tubes are dimensioned and configured to be joined together by hardware to form a framing for the gate, with the gate being hingedly connected to the framing for the containment system;
a plurality of removable fence tubes, the fence tubes being configured to be slidably received within aligned openings along the first horizontal support tubes to form sides;
a plurality of gate tubes, the gate tubes being configured to be slidably received within aligned openings along the second horizontal support tubes;
nesting substantially all of the fence tubes within selected first horizontal support tubes and selected first vertical support tubes within the box;
nesting substantially all of the gate tubes within selected first horizontal support tubes and selected first vertical support tubes within the box; and
securing the box.

10. The method of claim 9, wherein securing the box comprises taping edges of the box, wrapping the box with tape, wrapping the box with one or more straps, or combinations thereof

11. The method of claim 9, further comprising:
nesting at least two of the fence tubes within a selected second vertical support tube within the box.

12. The method of claim 9, further comprising:
nesting at least two of the gate tubes within a selected second vertical support tube within the box.

13. The method of claim 9, wherein the box is fabricated from cardboard or plastic.

14. The method of claim 9, wherein the box is about 6 feet in length, two feet in width, and one foot in thickness.

15. The method of claim 9, wherein, when assembled, the animal containment system is about five feet in length, five feet in width, and five feet in height.

16. The method of claim 9, wherein the components of the animal containment system further comprise a tarp configured to provide a cover over the animal containment system when the system is assembled.
